(19) United States
(12) Patent Application Publication
(10) Pub. No.: US 2004/0184813 A1
(43) Pub. Date: Sep. 23, 2004

(54) Dispersion compensation controlling apparatus and dispersion compensation controlling method

(76) Inventor: Satoshi Mikami, Morioka (JP)

Correspondence Address: SWIDLER BERLIN SHEREFF FRIEDMAN, LLP, 3000 K STREET, NW, BOX IP, WASHINGTON, DC, 20007, US

(21) Appl. No.: 10/766,024

(22) Filed: Jan. 29, 2004

(30) Foreign Application Priority Data
Jan. 31, 2003 (JP) 2003-023649

(51) Int. Cl. H04B 10/12

(52) U.S. Cl. 398/147

(57) ABSTRACT

The amount of dispersion compensation of a variable dispersion compensator that compensates for wavelength dispersion of an optical signal with waveform degradation caused by a characteristic of wavelength dispersion of an optical fiber is controlled by a controlling circuit based on bit-error information determined by a monitoring circuit so that the bit error rate is minimized. At initial setting, the bit error rate is determined by sweeping across a variable range of the amount of dispersion compensation of the variable dispersion compensator, and the amount of dispersion compensation is set as the initial value at the minimum value of the bit error rate, or at center value in a range of the amount of dispersion compensation when the bit error rate becomes lower than a preset threshold. The sweeping across the range of the amount of dispersion compensation where detection of synchronization cannot be performed is skipped.

### BACKGROUND OF THE INVENTION

1. Field of the Invention

The present invention relates to an apparatus for controlling compensation of dispersion (hereinafter called “dispersion compensation controlling apparatus”) and a method for controlling compensation of dispersion (hereinafter called “dispersion compensation controlling method”) capable of long-distance and large-capacity transmission in which waveform degradation of optical signals is compensated for by a variable compensator of dispersion (hereinafter called “variable dispersion compensator”).

2. Description of the Related Art

The transmission speed of recent optical transmission systems has become high, and 10-Gbit/s optical transmission systems have been commercially available. Even 40-Gbit/s optical transmission systems are being developed. Wavelength division multiplexing technology helps develop, for example, optical transmission systems for multiplexing 1000 wavelengths of 10-Gbit/s optical signals and collectively amplifying the multiplexed optical signals for transmission.

As the transmission speed becomes higher and higher, the waveform degradation of optical signals caused by wavelength dispersion in an optical fiber becomes noticeable, which is the main reason for the limited transmission distance. A dispersion compensating fiber is used to compensate for wavelength dispersion in the optical fiber. This allows long-distance transmission over several hundred kilometers. In higher-speed transmission such as about 40-Gbit/s transmission, which is more greatly influenced by wavelength dispersion, wavelength dispersion in the optical fiber must be precisely compensated for in order to allow long-distance transmission over several hundred kilometers, and a change in the characteristics of wavelength dispersion caused by a temperature change in the optical fiber is not negligible.

Various mechanisms for compensating for wavelength dispersion have been proposed. FIG. 16 is a diagram of a mechanism of the related art including a dispersion compensator. A receiving apparatus 100 includes a dispersion compensator 101, an optical filter 102, an optical/electric conversion section (O/E) 103, a data identification section 104 having clock regenerating means, an error detection section 105, an error rate calculation section 106, an error-rate-change calculation section 107, and a compensation-amount calculation section 108. A dispersion compensator 111 is arranged at a remote place in the transmission path of optical fiber.

The receiving apparatus 100 receives an optical signal transmitted via an optical fiber. The dispersion compensator 101 compensates for wavelength dispersion of the received optical signal. The optical filter 102 extracts an optical signal containing a signal component, and the O/E 103 converts the optical signal into an electrical signal. The data identification section 104 extracts a clock to identify data based on the extracted clock. The error detection section 105 performs error detection or error correction on the input data, and outputs the resulting received signal to a subsequent apparatus (not shown).

The error rate calculation section 106 calculates the error rate based on an error detection signal generated by the error detection section 105. The error-rate-change calculation section 107 calculates the amount of change in the error rate, and outputs the result to the compensation-amount calculation section 108. The compensation-amount calculation section 108 calculates the amount of dispersion compensation so as to control the dispersion compensator 101. Specifically, the compensation-amount calculation section 108 controls the amount of dispersion compensation of the dispersion compensator 101 so that the error rate does not increase. As is disclosed in Japanese Unexamined Patent Application Publication No. 2001-77756, the dispersion compensator 111 may be provided in an optical signal transmitter or repeater and may be controlled based on the amount of dispersion compensation calculated by the compensation-amount calculation section 108.

Japanese Unexamined Patent Application Publication No. 2002-208892 describes a mechanism capable of high-speed and large-capacity transmission that controls a dispersion compensator so that the error rate calculated in the above-described manner decreases to compensate for both wavelength dispersion and polarization mode dispersion.

Like such a dispersion compensator, in a variable dispersion compensator having a controllable amount of dispersion compensation, it is conceivable that the amount of dispersion compensation is controlled by, for example, optically or mechanically switching the length of dispersion compensating fiber, while increasing the size and complexity of the variable dispersion compensator. Japanese Unexamined Patent Application Publication No. 2001-77756 also describes a structure using the phenomenon of a temperature change causing the amount of wavelength dispersion to change, in which a current corresponding to the amount of dispersion compensation is supplied to thin film heaters disposed along the optical fiber to adjust the temperature so as to control the amount of dispersion compensation. Shirasaki et al., “Dispersion Compensation Using The Virtually Imaged Phased Array”, APCC/OSCC'99, pp. 1367-1370, 1999, describes a VIPA (Virtually Imaged Phased Array) device that compensates for wavelength dispersion by wavelength-division demultiplexing and multiplexing by controlling the respective lengths of optical path. Optical devices using an FBG (Fiber Bragg Grating) are also known. Optical devices that monitor the frequency component of half or one quarter of the clock contained in a dispersion-compensated optical signal to control dispersion compensation are also known.

In the related art, a device for controlling dispersion compensation so that the error rate is minimized is generally used to compensate for wavelength dispersion in optical transmission systems. As shown in, for example, FIG. 17, where the x-axis represents the amount of dispersion compensation and the y-axis represents the error rate, it is assumed that the amount of dispersion compensation at a point al denoted by a black circle is indicated by Dstart. When dispersion compensation is controlled so that the error rate is minimized, the relationship between the error rate and the amount of dispersion compensation exhibits a V-shaped or U-shaped characteristic. It is not initially determined whether the error rate decreases or increases at the slope portion of the characteristic when the amount of dispersion compensation increases.

When the amount of dispersion compensation changes from Dstart to D2, the point a1 changes to a point a2. As is apparent from this transition, the error rate increases. The amount of dispersion compensation changes in the opposite direction to D3, and the point a2 transitions to a point a3. At the point a3, the amount of change in the error rate is large, and the amount of dispersion compensation changes to D1. Then, the point a3 changes to a point a4, and the error rate increases. The amount of dispersion compensation changes to D4, and the point a4 changes to a point a5. Therefore, when the amount of dispersion compensation is controlled based on the error rate, a problem occurs in that it takes a long time to calculate the amount of dispersion compensation for the minimum error rate.

The relationship between the error rate and a residual dispersion value exhibits a substantially U-shaped characteristic, as shown in, for example, FIG. 18A. However, the characteristic actually contains a fluctuation band W. As shown in the enlarged version thereof in FIG. 18B, for example, if wavelength dispersion control is performed so that the error rate is minimized, a point b1 is almost ideal, but the error rate is also minimum at a point b2. That is, when the amount of dispersion compensation is controlled so that the error rate is not higher than a threshold Eth1, the error rate increases from the point b2 if the amount of dispersion compensation is continuously controlled, and the point b2 is therefore regarded as the minimum value of the error rate for controlling the variable dispersion compensator. At the point b2, the error rate exceeds the threshold Eth1 if the amount of dispersion compensation slightly varies, leading to a problem that communication is not possible due to the increased error rate.

When the error rate is very low, the variable range of the amount of wavelength dispersion, which is the lowest limit possible to calculate the error rate, increases. For example, in FIG. 18A, the characteristic of the error rate may be in some cases defined by substantially perpendicular lines rather than by a U-shaped curve. In such cases, when the amount of dispersion compensation is controlled at a point in the vicinity of the lines where the error rate becomes the lowest, a slight fluctuation of the amount of dispersion compensation causes the error rate to rapidly increase over the threshold Eth1. This results in a problem in that normal communication is not possible.

The initial setting of the amount of dispersion compensation of the variable dispersion compensator is performed when the system starts. The error rate is generally low, thus leading to a problem in that it takes a long time to set the error rate to the minimum value and the problem described above with reference to FIG. 18B.

### SUMMARY OF THE INVENTION

Accordingly, in order to overcome the problems with the related art, it is an object of the present invention to perform high-speed initial setting of the amount of dispersion compensation and stable control of the amount of dispersion compensation.

In an aspect, the present invention provides a dispersion compensation controlling apparatus for compensating for waveform degradation of an optical signal caused by a wavelength dispersion characteristic of an optical transmission path. And, as an index of quality of transmission path, bit error and/or bit error rate is adopted. The dispersion compensation controlling apparatus includes a variable dispersion compensator for compensating for waveform degradation of an optical signal, monitoring circuits for generating bit-error information of the optical signal compensated by the variable dispersion compensator, and a controlling circuit for controlling the amount of dispersion compensation of the variable dispersion compensator so that the bit error rate is minimized based on the bit-error information from the monitoring circuits. The controlling circuit sweeps across a variable range of the amount of dispersion compensation of the variable dispersion compensator to thereby determine the bit error rate, and sets the amount of dispersion compensation corresponding to the minimum value of the bit error rate or sets a center value in a range of the amount of dispersion compensation when the bit error rate becomes lower than a preset threshold, as the initial value.

The controlling circuit further sweeps across the variable range of the amount of dispersion compensation of the variable dispersion compensator to thereby execute a detection of synchronization and/or determination of the bit error rate. When the synchronization is not detected, the sweeping is skipped over a designated step to find the initial value.

In another aspect, the present invention provides a dispersion compensation controlling method of compensating for waveform degradation of an optical signal caused by a wavelength dispersion characteristic of an optical transmission path. In the dispersion compensation controlling method, wavelength dispersion of the optical signal with waveform degradation is compensated for by the variable dispersion compensator, the bit error rate is determined based on the bit-error information of the optical signal for which the wavelength dispersion has been compensated, and the amount of dispersion compensation of the variable dispersion compensator is controlled so that the bit error rate is minimized. At initial setting, the dispersion compensation controlling method also includes the steps of sweeping across a variable range of the amount of dispersion compensation of the variable dispersion compensator to thereby determine the bit error rate, and setting the amount of dispersion compensation corresponding to the minimum value of the bit error rate, or setting a center value in a range of the amount of dispersion compensation when the bit error rate becomes lower than a preset threshold, as the initial value.

At initial setting, the dispersion compensation controlling method can include the steps of sweeping across the variable range of the amount of dispersion compensation of the variable dispersion compensator to thereby execute a determination of the bit error rate and a detection of synchronization, and determining the bit error rate by skipping the sweeping by a designated step when synchronization is not detected. The bit error rate has a control beginning threshold (suiting to first threshold) and a searching threshold (suiting to second threshold) having a greater bit error rate than the control beginning threshold. When the bit error rate is within a range of lowest values below the control beginning threshold, the amount of dispersion compensation at the center of the range of lowest values is set as the initial value in the variable dispersion compensator. In operation, the dispersion compensation controlling method can include the steps of, when the bit error rate becomes higher than the control beginning threshold, sweeping across the variable range of the amount of dispersion compensation of the variable dispersion compensator so that the amount of dispersion compensation at the center of the range of lowest values of the bit error rate is set again.

According to the present invention, therefore, a variable dispersion compensator that compensates for waveform degradation of an optical signal is controlled by a controlling circuit, thus allowing optical communication with the bit error rate being minimized. At initial setting, the characteristic of the bit error rate can be determined by sweeping across a variable range of the amount of dispersion compensation to thereby be able to set the amount of dispersion compensation to the best point so that the bit error rate is minimized. At initial setting, the sweeping across a variable range of the amount of dispersion compensation can be skipped until the detection of synchronization can be performed, thus increasing the initial setting operation speed. In operation, when the characteristic of wavelength dispersion of the optical transmission path greatly changes, the amount of dispersion compensation is reset, thus allowing stable control of dispersion compensation during long-term operation of the optical transmission system.

### BRIEF DESCRIPTION OF THE DRAWINGS

FIG. 1 is a principle diagram of a dispersion compensation controlling apparatus according to the present invention;

FIG. 2 is a diagram of a dispersion compensation controlling apparatus according to an embodiment of the present invention;

FIG. 3 is a diagram of a dispersion compensation controlling apparatus according to another embodiment of the present invention;

FIG. 4 is a diagram of a monitoring circuit;

FIGS. 5A to 5D are views showing an initial setting operation;

FIGS. 6A to 6D are views showing the initial setting operation;

FIGS. 7A and 7B are views showing the initial setting operation;

FIGS. 8A to 8C are views showing an initial setting operation;

FIG. 9 is a flowchart of a dispersion compensation system according to an embodiment of the present invention;

FIG. 10 is a flowchart of the dispersion compensation system according to the embodiment of the present invention;

FIGS. 11A and 11B are views showing control during operation;

FIGS. 12A and 12B are views showing bit-error-rate-based control during operation;

FIG. 13 is a schematic diagram of the controlling circuit shown in FIG. 2;

FIG. 14 is a schematic diagram of the controlling circuit shown in FIG. 3;

FIG. 15 is a diagram of a controlling circuit according to an embodiment of the present invention;

FIG. 16 is a diagram of a mechanism of the related art;

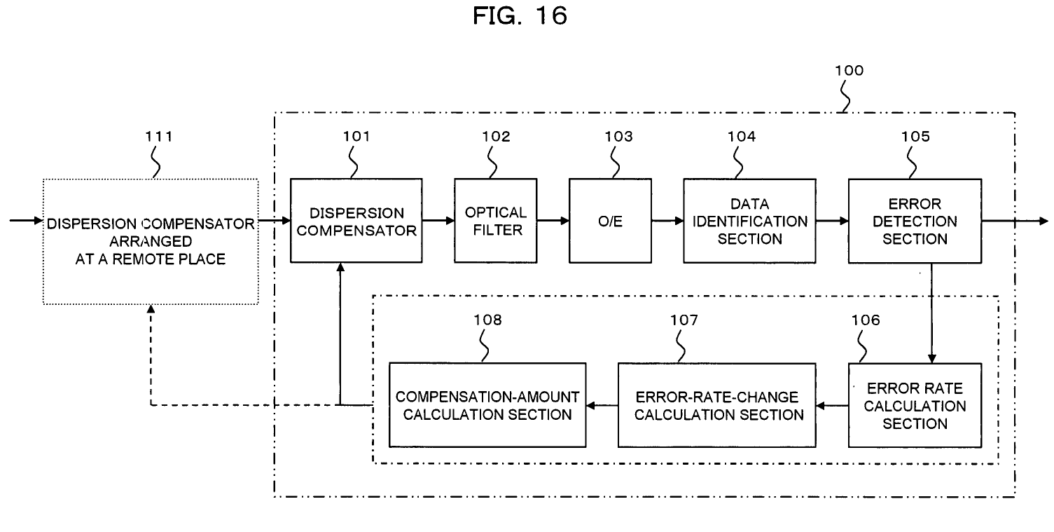

FIG. 17 is a view showing a controlling method of following a minimum value of the related art; and

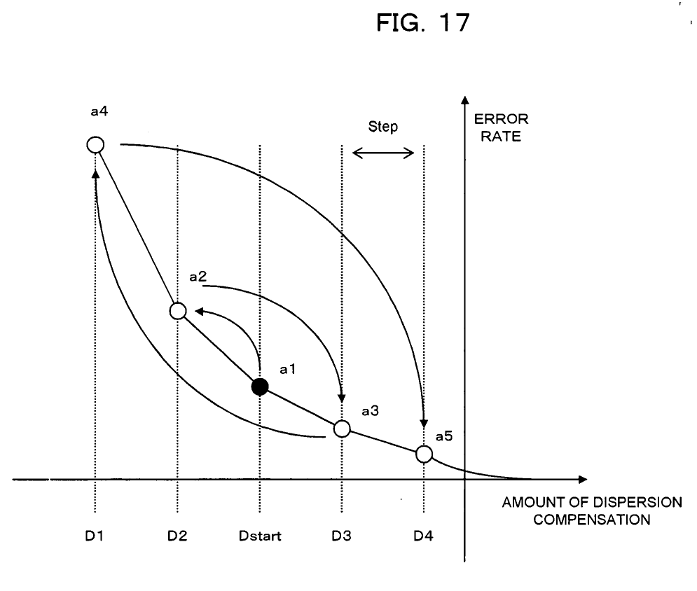

FIGS. 18A and 18B are views showing the relationship between the error rate and a residual dispersion value.

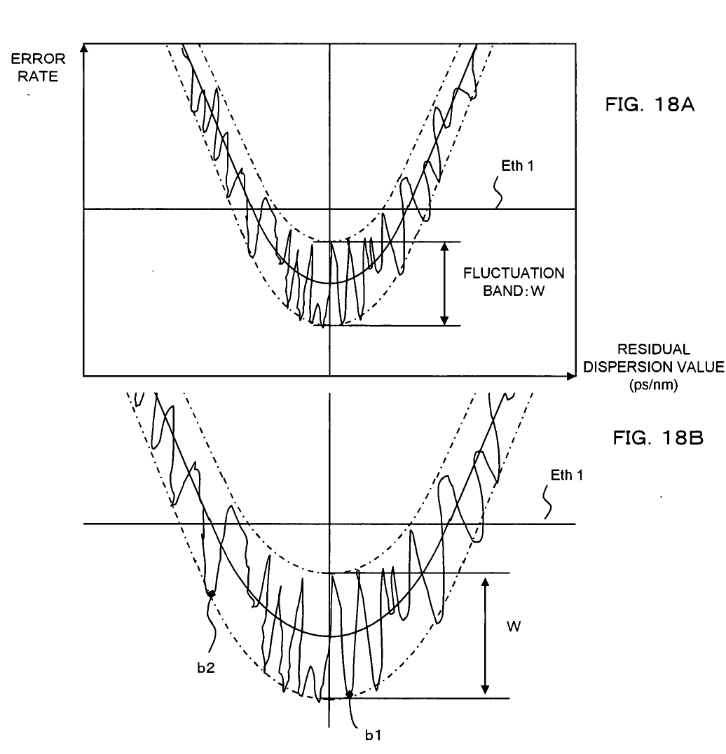

### DESCRIPTION OF THE PREFERRED EMBODIMENTS

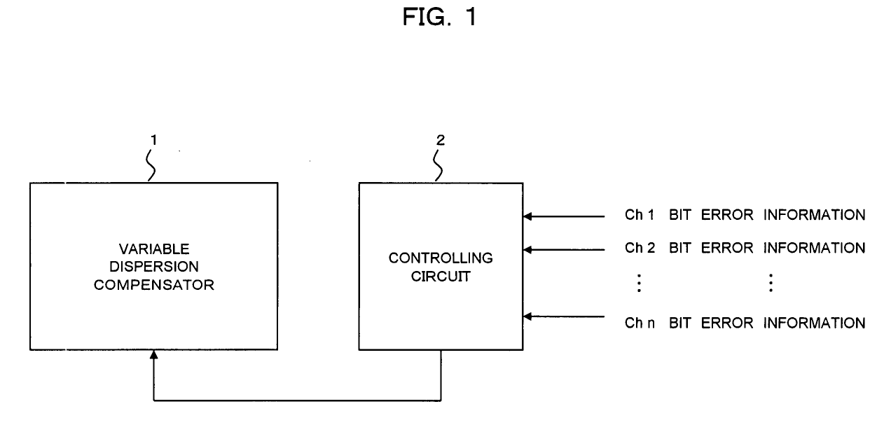

FIG. 1 is a principle diagram of a dispersion compensation controlling apparatus according to the present invention, showing a variable dispersion compensator 1 and a controlling circuit 2. The variable dispersion compensator 1 performs collective dispersion compensation for a wavelength-multiplexed optical signal for channels Ch1 to Chn. A demultiplexer (not shown) or the like demultiplexes it into wavelengths corresponding to the channels Ch1 to Chn to convert it into an electrical signal to identify data, and determines the bit error rate of the data. The controlling circuit 2 receives bit-error information corresponding to each of the channels Ch1 to Chn, and controls the variable dispersion compensator 1 so that the overall bit error rate is minimized.

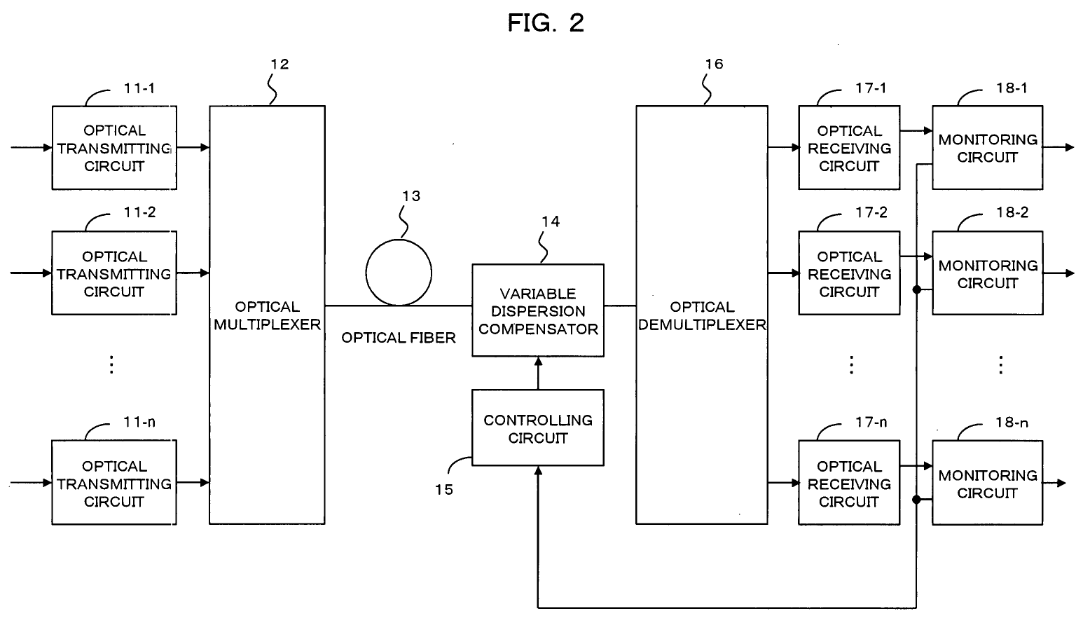

FIG. 2 is a diagram of a dispersion compensation controlling apparatus according to an embodiment of the present invention, showing optical transmitting circuits 11-1 to 11-n, an optical multiplexer 12, an optical fiber 13, a variable dispersion compensator 14, a controlling circuit 15, an optical demultiplexer 16, optical receiving circuits 17-1 to 17-n, and monitoring circuits 18-1 to 18-n.

The optical transmitting circuits 11-1 to 11-n corresponds to the channels Ch1 to Chn, respectively. The optical multiplexer 12 multiplexes optical signals of different wavelengths, and transmits the wavelength-multiplexed optical signals via the optical fiber 13. The variable dispersion compensator 14 collectively compensates for the optical signals, wherein wavelength dispersion is caused by the wavelength dispersion characteristic of the optical fiber 13. The variable dispersion compensator 14 and the controlling circuit 15 correspond to the variable dispersion compensator 1 and the controlling circuit 2 shown in FIG. 1, respectively.

The optical demultiplexer 16 demultiplexes the optical signals into wavelengths of the channels Ch1 to Chn. The optical receiving circuits 17-1 to 17-n converts the demultiplexed optical signals into electrical signals to identify the data. The monitoring circuits 18-1 to 18-n monitor the identified data, and determine the bit error rate as the state of the transmission path, which is then output to the controlling circuit 15. The controlling circuit 15 controls the variable dispersion compensator 14 so that the bit error rate is minimized. This allows continuity of optical signal communication with a low bit error rate even when the characteristics of wavelength dispersion of the optical transmission path change due to a temperature change etc.

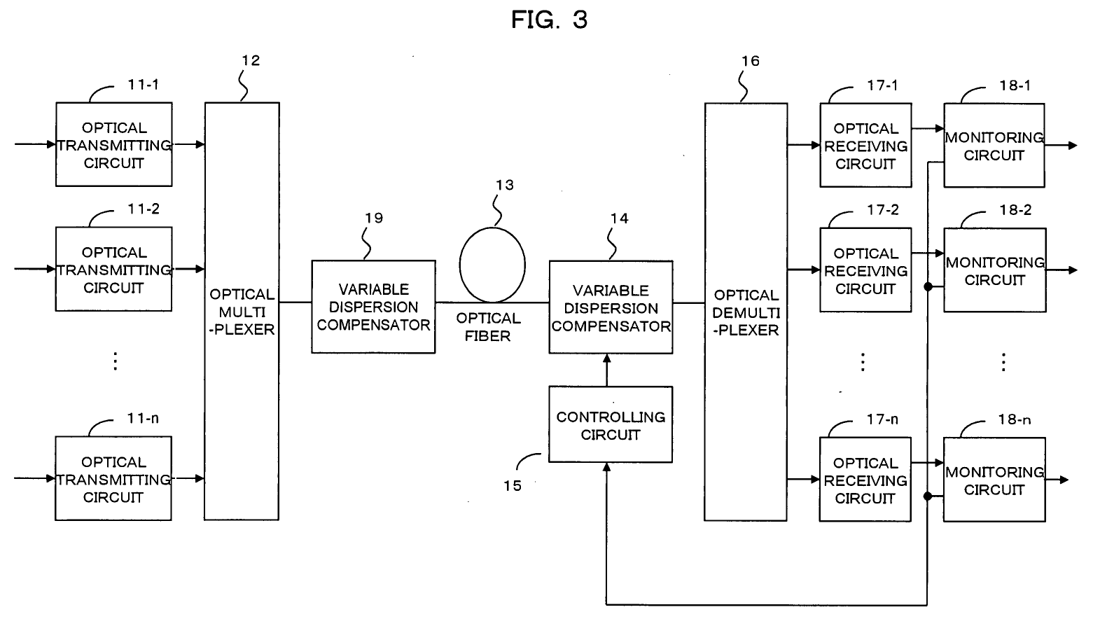

FIG. 3 is a diagram of a dispersion compensation controlling apparatus according to another embodiment of the present invention. In FIG. 3, the same reference numerals as those shown in FIG. 2 indicate the same elements, and a variable dispersion compensator 19 on the transmitter side is further shown. The controlling circuit 15 controls the variable dispersion compensator 19 on the transmitter side and the variable dispersion compensator 14 on the receiver side so that the bit error rate detected by the monitoring circuits 18-1 to 18-n is minimized.

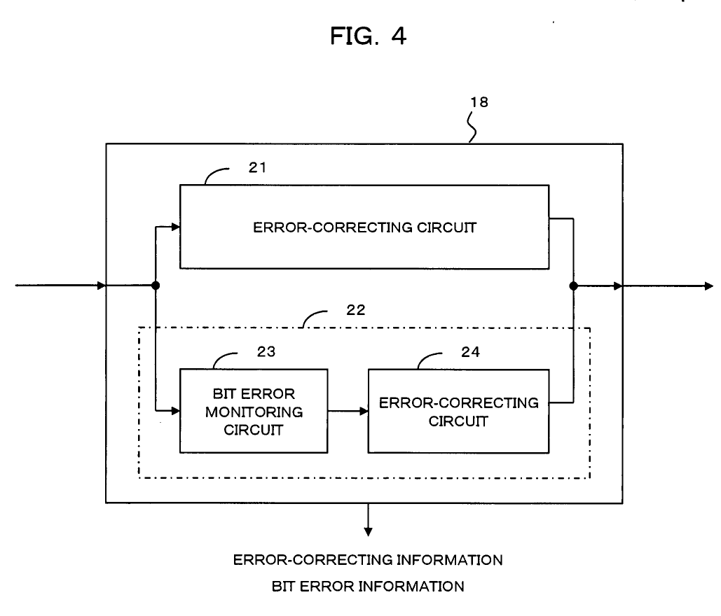

FIG. 4 is a diagram of a monitoring circuit 18 for monitoring the state of the transmission path, which corresponds to each of the monitoring circuits 18-1 to 18-n shown in FIGS. 2 and 3. For example, the monitoring circuit 18 includes an error-correcting circuit 21, or a watching circuit 22 having a bit error monitoring circuit 23 and an error-correcting circuit 24. The monitoring circuit 18 transfers error-correction information obtained by error correction or bit-error information obtained by error detection before error correction to the controlling circuit 15. A synchronous detection circuit of synchronization (not shown) detects frame synchronization, etc., and transfers the information of detection of frame synchronization to the controlling circuit 15.

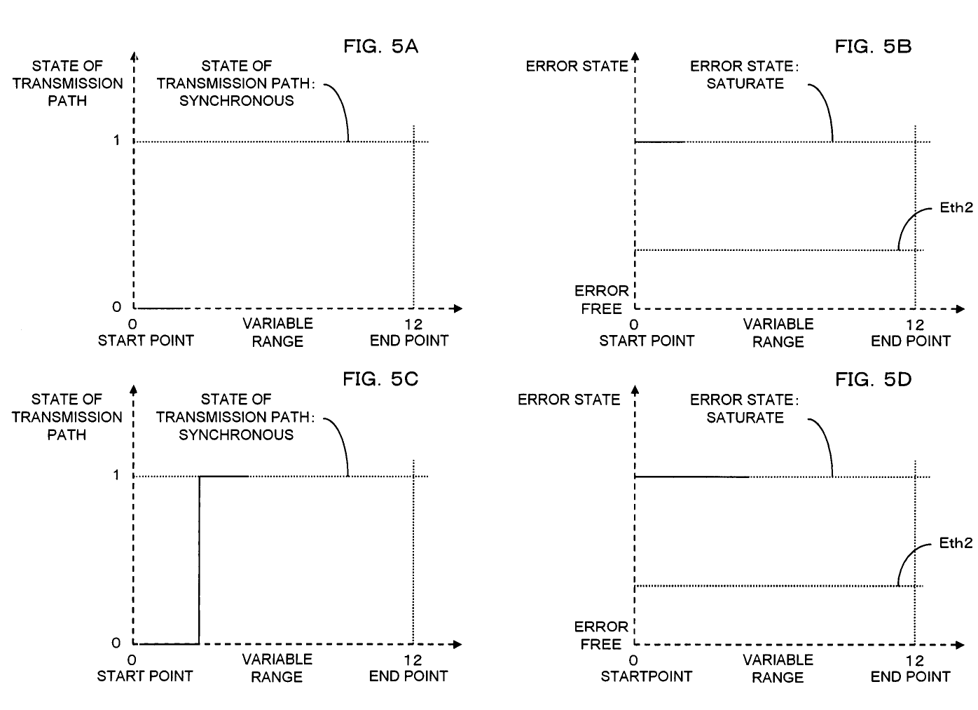

FIGS. 5A through 7B are views showing an initial setting operation. FIGS. 5A, 5C, 6A, 6C, and 7A show the state of the transmission path, and FIGS. 5B, 5D, 6B, 6D, and 7B show the error state (bit error rate). In the present invention, at initial setting such as when starting the system, the controlling circuit 15 sweeps across a variable range of the amount of dispersion compensation of the variable dispersion compensator 14 to determine the relationship between the amount of dispersion compensation and the bit error rate. Detection of synchronization is also performed to determine the state of the transmission path. The detection of synchronization can be carried out by, for example the monitoring circuit 18. In FIGS. 5A through 7B, the x-axis represents the variable range of the amount of dispersion compensation across which the controlling circuit 15 sweeps, as expressed by the sweep start point and the sweep end point. The state of the transmission path is indicated by “1” for synchronization detecting or “0” for synchronization coming off. The error state has a saturation level indicating the maximum level possible to calculate the bit error rate, an error free level indicating the minimum level possible to calculate the bit error rate, and a threshold Eth2 indicating the limit of the bit error rate possible for continuity of the operation. The threshold Eth2 may be, for example, a bit error rate of 10 ⁻⁹.

FIGS. 5A and 5B show that a sweep starts at the start point, where the state of the transmission path is “0” or in the synchronization-coming-off state and the error state indicates that the bit error rate is in the saturation level. For example, in SDH (Synchronous Digital Hierarchy) or SONET (Synchronous Optical Network), detection of synchronization is performed using the A1 and A2 bytes in the section overhead of a transmission frame, as known in the art.

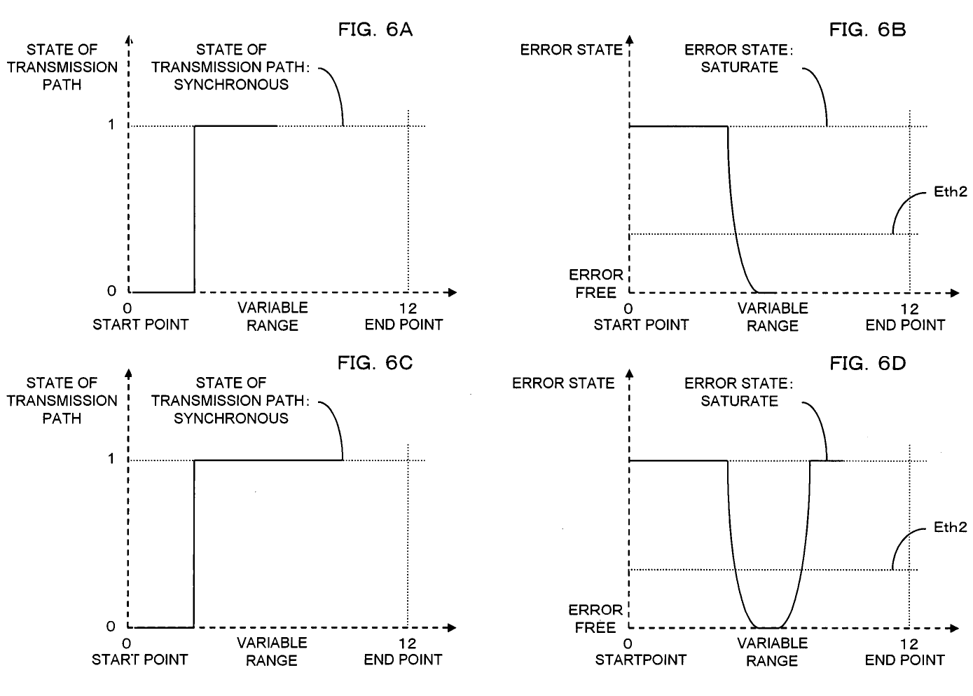

When the bit error rate is high, detection of synchronization cannot be performed, and the state of the transmission path is “0”. In this case, the sweeping of the amount of dispersion compensation is skipped by a designated step. Then, the states shown in FIGS. 5A and 5B changes to the states shown in FIGS. 5C and 5D, respectively. In the state of the transmission path where the bit error rate is improved to some extent so as to perform detection of synchronization, the amount of dispersion compensation is continuously swept. In this state, the error state still indicates the saturation level. During sweeping the amount of dispersion compensation, the states shown in FIGS. 5C and 5D changes to the states shown in FIGS. 6A and 6B, respectively. The error state indicates that the bit error rate is reduced to the lowest level (the error free level).

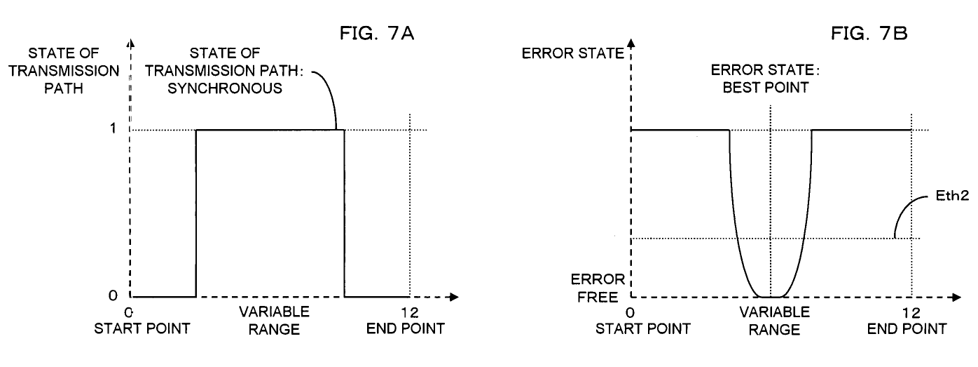

When the sweeping further continues, the states shown in FIGS. 6A and 6B changes to the states shown in FIGS. 6C and 6D, respectively. The state of the transmission path is the synchronization-detection state (“1”), and the error state indicates that the bit error rate increases to the saturation level. When the sweeping further continues, the states shown in FIGS. 6C and 6D changes to the states shown in FIGS. 7A and 7B, respectively. The transmission path goes to the synchronization-coming-off state (“0”), and the error state indicates the saturation level. In the synchronization-coming-off state, the sweeping is skipped by a designated step, as described above. Based on the characteristic of the bit error rate shown in FIG. 7B, the best point can be determined. Specifically, the value of the amount of dispersion compensation at the minimum value or at the center of a range of the amount of dispersion compensation when the bit error rate becomes lower than a preset threshold is set as the best point.

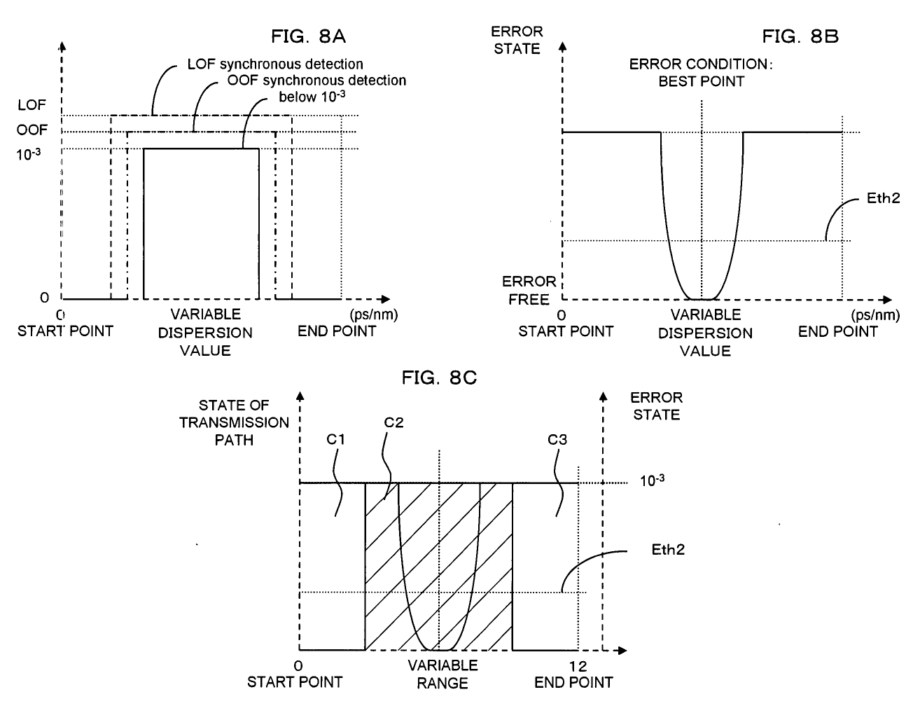

FIG. 8A shows an example in which a variable dispersion value is swept from the start point to the end point, showing conditions of LOF (Loss of Frame) detection of synchronization, OOF (Out of Frame) detection of synchronization, and a bit error rate of 10⁻³ or lower. In this example, detection of synchronization includes LOF detection of synchronization and OOF detection of synchronization, and also includes the bit error rate condition. The Error state obtained by sweeping the variable dispersion value is shown in FIG. 8B.

FIG. 8C shows a combination of the characteristics shown in FIGS. 8A and 8B. In FIG. 8C, regions c1 and c3 indicate “0” as a result of the logical-add operation under the conditions of LOF detection of synchronization, OOF synchronous detection, and a bit error rate of 10⁻³ or lower, and a region c2 indicates “1” as a result of the logical-add operation. At initial setting, the sweeping is skipped, for example, wherein the width of a single sweep in the regions c1 and c3 is four times the width of the sweep in the region c2, thus accelerating the initial setting operation speed.

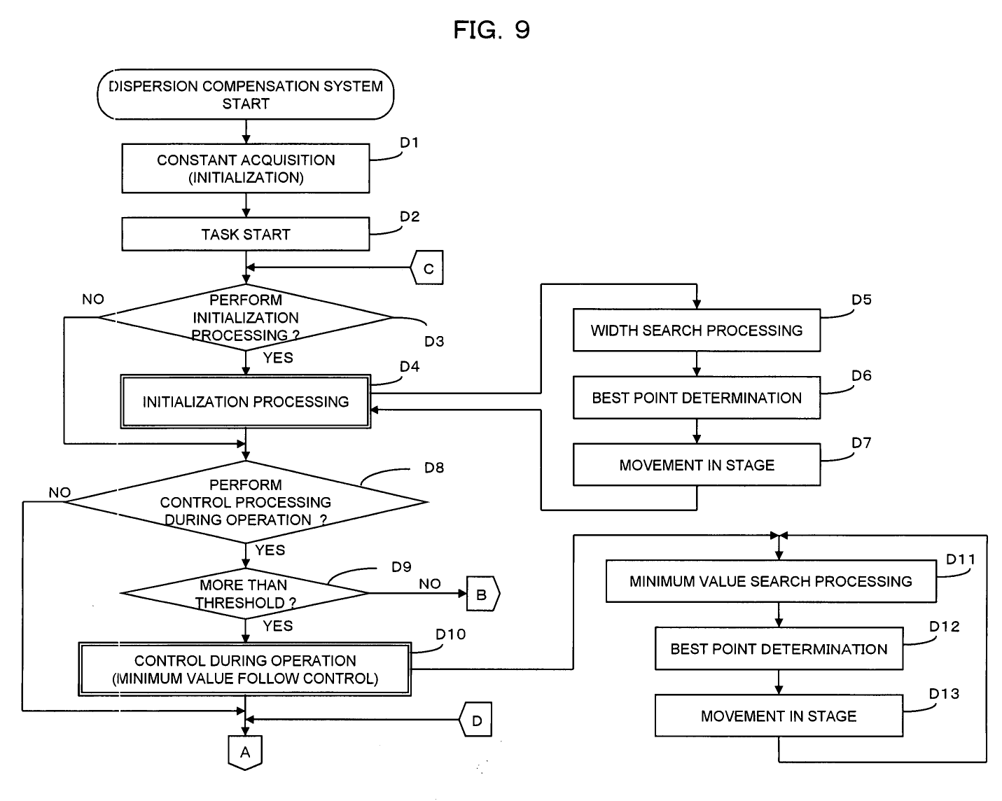

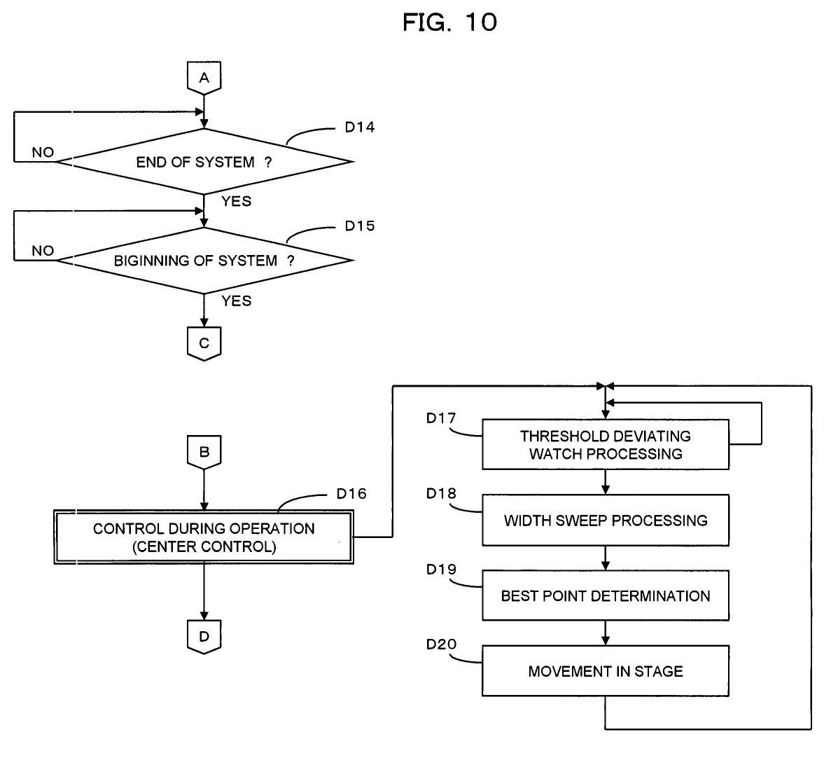

FIGS. 9 and 10 are flowcharts of a dispersion compensation system according to an embodiment of the present invention. The dispersion compensation system starts constant acquisition (initialization) (step D1) and starts a task (step D2). It is determined whether or not initialization processing is to be performed (step D3). If initialization processing is not to be performed, in step D8, it is determined whether or not control processing during operation is to be performed. If it is determined in step D3 that initialization processing is to be performed, the initialization processing is performed (step D4).

The initialization processing includes width search processing (step D5), determining of best point (step D6), and movement in stages (step D7). In the width search processing (step D5), as described above, the variable range of the amount of dispersion compensation is swept. In the processing of determining of best point (step D6), the state of the transmission path and the error state are detected to calculate the best value of the amount of dispersion compensation at the minimum value of the bit error rate, or at the center value in a range of the amount of the dispersion compensation when the bit error rate becomes lower than a preset threshold. As described above with reference to FIGS. 8A through 8C, the conditions of LOF detection of synchronization, OOF detection of synchronization, and a bit error rate of 10⁻³ or lower can be set in the state of the transmission path.

If it is determined in step D8 that control processing during operation is to be performed, it is determined whether or not the bit error rate is more than a threshold (step D9). If the bit error rate is not more than the threshold, the process proceeds to step D16 shown in FIG. 10. If the bit error rate is more than the threshold, during operation, controlling to follow to a minimum value (hereinafter called “minimum value follow control”) is performed in step D10. The control during operation includes the processing of searching minimum value of bit error rate (step D11), determining of best point (step D12), and movement in stages (step D13). After the control during operation in step D10, the process proceeds to step D14 shown in FIG. 10.

In step D14, it is determined whether or not the system terminates. In other words, an end event from abnormal watch processing is queued in step D14. If the system terminates, it is determined in step D15 whether or not the system should restart. In this step, a beginning event from the abnormal watch processing is queued. In the beginning event, it is determined that the system should start, and the process returns to step D3.

If it is determined in step D9 that the bit error rate is not more than the threshold, a control during operation (controlling to search a center value) is performed in step D16. The control during operation includes the processing of watching that a bit error rate becomes higher than a threshold (step D17), the processing of sweeping across a variable range of an amount of dispersion compensation (step D18), and determining of best point (step D19) in which the amount of dispersion compensation is controlled to a center value in a range of the amount of dispersion compensation when the bit error rate becomes lower than a preset threshold, and movement in stages (step D20). Then, the process returns to step D14, in which it is determined whether or not the system terminates.

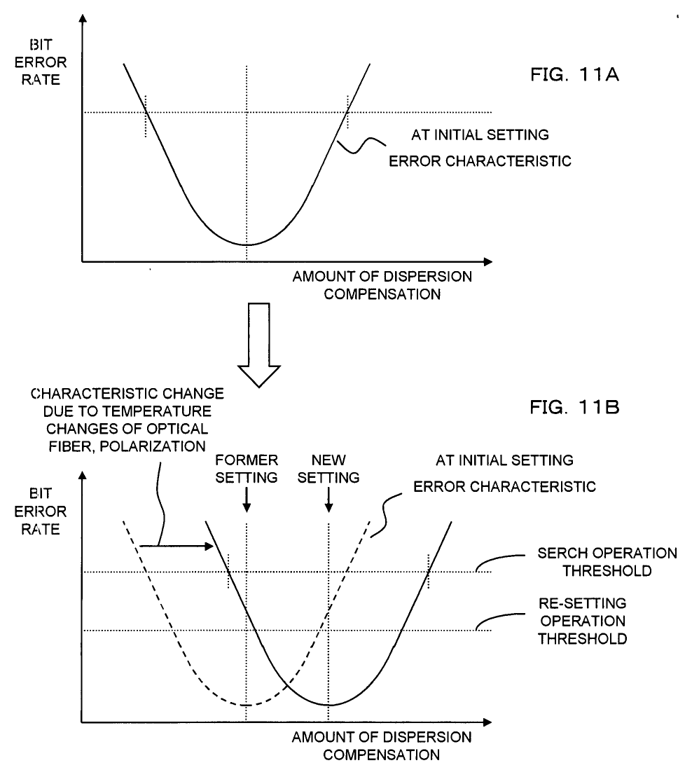

FIGS. 11A and 11B are views showing control during operation, in which FIG. 11A shows a characteristic of the dispersion value of the variable dispersion compensator versus the bit error rate at initial setting. In the state shown in FIG. 11A, the amount of dispersion compensation of the variable dispersion compensator is set so that the bit error rate is minimized. Due to temperature changes of the optical transmission path, polarization dispersion changes, and the like, the characteristic may change from the state indicated by a dotted line in FIG. 11B to the state indicated by a solid line. When the bit error rate increases over a predetermined search operation threshold (suiting to second threshold)due to the characteristic change, the control during operation of step D10 is performed to control the amount of dispersion compensation of the variable dispersion compensator to the best point so that the bit error rate is minimized. When the bit error rate increases over a predetermined re-setting operation start threshold (suiting to first threshold), the control during operation of step D16 is performed to reset the amount of dispersion compensation of the variable dispersion compensator to the best position.

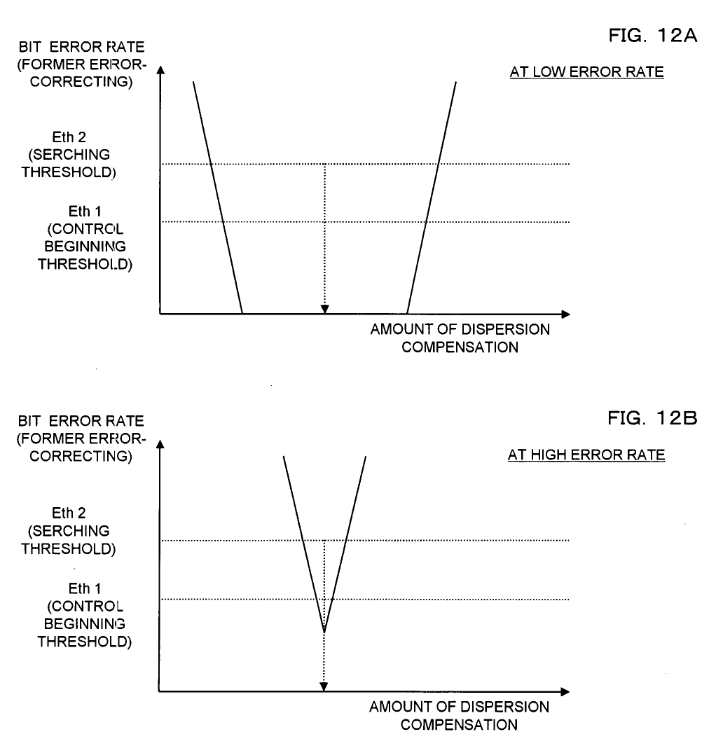

FIGS. 12A and 12B are views showing bit-error-rate-based control during operation, showing a low bit error rate case and a high bit error rate case, respectively. In FIGS. 12A and 12B, the y-axis represents the bit error rate, and the x-axis represents the amount of dispersion compensation. Eth2 denotes the searching threshold (suiting to second threshold) and Eth1 denotes the control beginning threshold (suiting to first threshold). The searching threshold Eth2 can correspond to the search operation threshold shown in FIG. 11B, and the control beginning threshold Eth1 can correspond to the re-setting operation start threshold shown in FIG. 11B.

When the bit error rate is very low and has a wide range of lowest values, for example, the amount of dispersion compensation wherein the bit error rate decreases below the searching threshold Eth2 (or the control beginning threshold Eth1) changes, and a center value in a range of the amount of dispersion compensation when the bit error rates becomes lower than the searching threshold Eth2 (or the control beginning threshold Eth1) is set as the set value. Therefore, the amount of dispersion compensation can be set to the best value at initial setting or resetting. In operation, the amount of dispersion compensation at the center of the range of lowest values of the bit error rate below the control beginning threshold Eth1 can be followed by constantly sweeping the amount of dispersion compensation in the range lower than the control beginning threshold Eth1.

When the bit error rate is high, exhibiting a V-shaped characteristic shown in FIG. 12B, the amount of dispersion compensation wherein the bit error rate becomes minimum below the control beginning threshold Eth1 is set as the initial value. In operation, the minimum value follow control (step D10) allows for control of the amount of dispersion compensation so that the bit error rate does not increase.

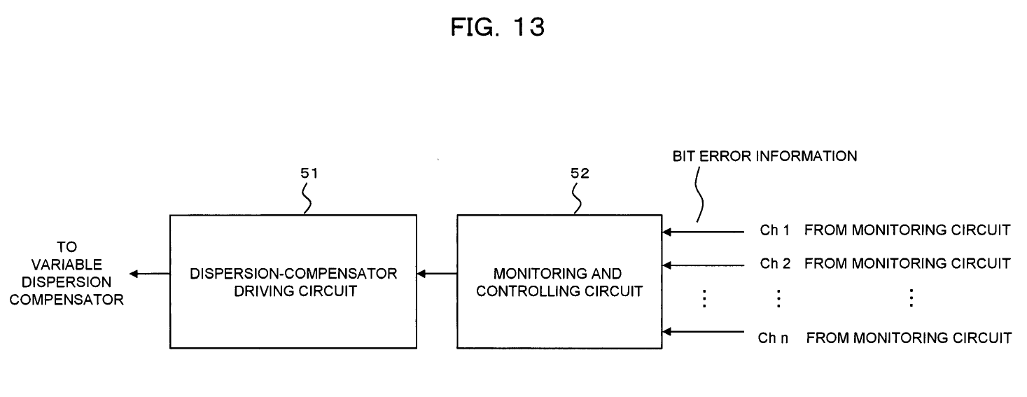

FIG. 13 is a schematic diagram of the controlling circuit 15 shown in FIG. 2, including a dispersion-compensator driving circuit 51 and a monitoring and controlling circuit 52. The monitoring and controlling circuit 52 receives the bit-error information from the monitoring circuits 18-1 to 18-n shown in FIG. 2 to determine the amount of control, and controls the dispersion-compensator driving circuit 51. The dispersion-compensator driving circuit 51 controls the variable dispersion compensator 14 shown in FIG. 2, which performs dispersion compensation collectively. For example, in a case where the variable dispersion compensator 14 controls the amount of dispersion compensation by controlling the temperature of an optical fiber having thin film heaters, the dispersion-compensator driving circuit 51 supplies a current in accordance with a control signal from the monitoring and controlling circuit 52 to the thin film heaters so as to control the amount of dispersion compensation. In a case where the variable dispersion compensator 14 includes a VIPA device, based on a driving signal in accordance with the control signal from the monitoring and controlling circuit 52, the dispersion-compensator driving circuit 51 controls the angle of incidence or reflection of the demultiplexed wavelengths to control the amount of dispersion compensation by controlling the equivalent optical path length.

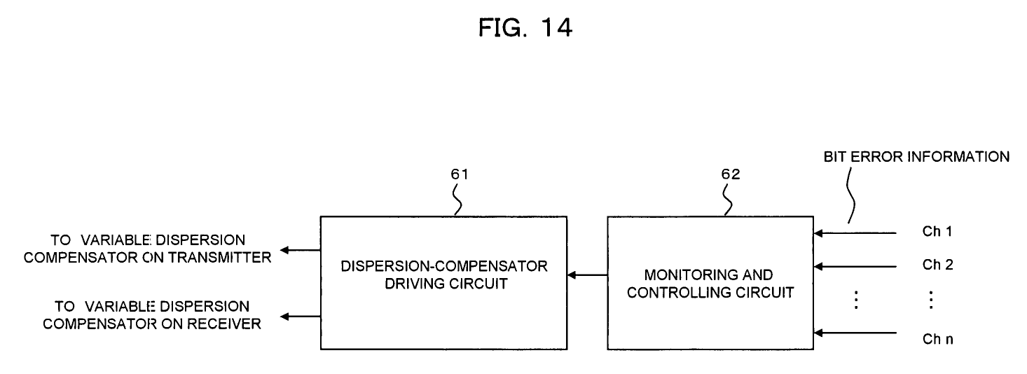

FIG. 14 is a schematic diagram of the controlling circuit 15 shown in FIG. 3, including a dispersion-compensator driving circuit 61 and a monitoring and controlling circuit 62. The monitoring and controlling circuit 62 has a similar structure to that of the monitoring and controlling circuit 52 shown in FIG. 13. The dispersion-compensator driving circuit 61 controls the variable dispersion compensator 19 on the transmitter side and the variable dispersion compensator 14 on the receiver side shown in FIG. 13, so that wavelength dispersion can be compensated both on the transmitter side and the receiver side.

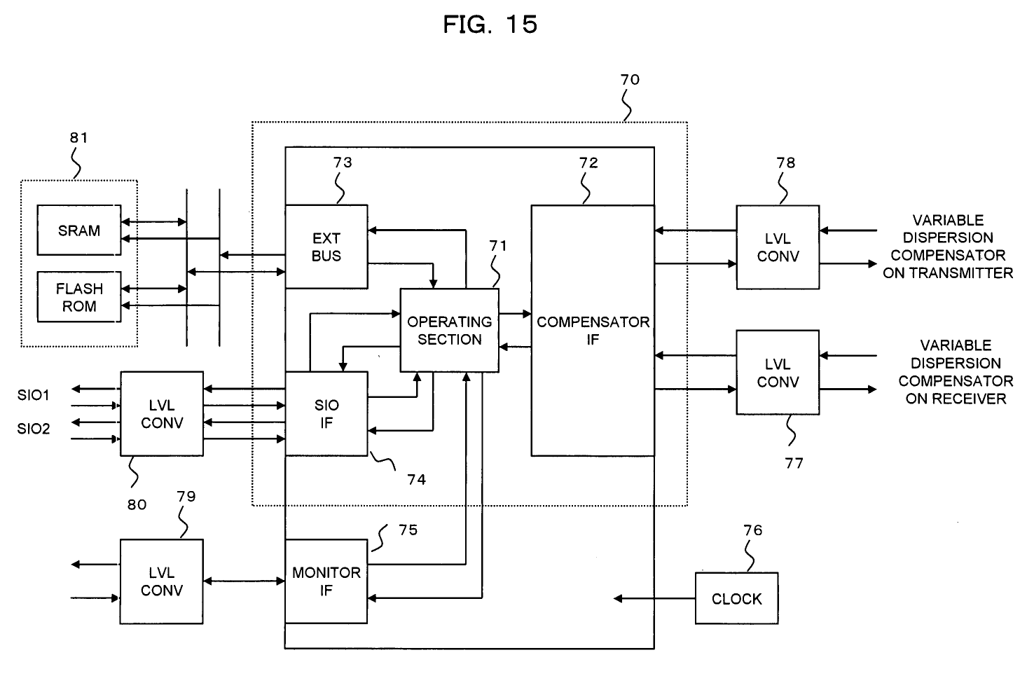

FIG. 15 is a diagram of a controlling circuit according to an embodiment of the present invention. The controlling circuit includes a best control operating section 70, an operating section 71, a compensator interfacing section (compensator IF) 72, an external bus driver/receiver (EXT BUS) 73, a system input/output interfacing section (SIO IF) 74, a monitor interfacing section (MONITOR IF) 75, a clock generating section (CLOCK) 76, level converting sections (LVL CONV) 77 through 80, and a memory section 81 having an SRAM (static random-access memory) and a FLASH ROM (read on memory that can be rewritten electrically).

Similarly to the controlling circuit shown in FIG. 14, the controlling circuit shown in FIG. 15 is able to control a variable dispersion compensator on the transmitter side and a variable dispersion compensator on the receiver side. The controlling circuit shown in FIG. 15 transmits and receives a control signal or the like to and from the variable dispersion compensator 14 on the receiver side via the level converting section 77, or transmits and receives a control signal or the like to and from the variable dispersion compensator 19 on the transmitter side via the level converting section 78 so as to transfer the control signal or the like for the amount of dispersion compensation determined by the operating section 71 to the variable dispersion compensator 14 or 19 via the compensator interfacing section 72 to control the amount of dispersion compensation. The controlling circuit also transmits and receives bit-error information or the like to and from the monitoring circuits 18-1 to 18-n via the level converting section 79, and transfers the bit-error information or the like to the operating section 71 via the monitor interfacing section 75.

The memory section 81 stores a program and various data necessary for dispersion compensation control, and, for example, stores best value of the amount of dispersion compensation on an average year, control history of the amount of dispersion compensation, and so on. The memory section 81 transfers data or the like to and from the operating section 71 via the external bus driver/receiver 73. The clock generating section 76 includes a device for generating a synchronous clock with the clock from the system or an independent device such as a crystal oscillator, and supplies a clock necessary for the internal processing operation.

The operating section 71 performs various operations according to a program for control at initial setting or control during operation based on the bit-error information from a monitoring circuit 18-1 to 18-n. At initial setting, the operating section 71 controls a sweep across the variable range of the amount of dispersion compensation, compares the bit error rate with a threshold, determines whether or not detection of synchronization can be performed, skips the sweep according to a result thereof, sets the best amount of dispersion compensation, etc. In operation, the operating section 71 compares the bit error rate with thresholds such as the control beginning threshold Eth1 and the searching threshold Eth2 to determine the amount of dispersion compensation of the variable dispersion compensator, and controls the amount of dispersion compensation so that the bit error rate is minimized. The monitoring circuit 18-1 to 18-n may perform detection of frame synchronization using the A1 and A2 bytes in the SDH or SONET frame section overhead to extract bit-error monitoring information using the B1 and B2 bytes in this section overhead, and may transfer bit-error information indicating transmission path anomalies or not to the controlling circuit.

What claimed is:

1. An apparatus for controlling compensation of dispersion for compensating for waveform degradation of optical signal caused by characteristic of wavelength dispersion on an optical transmission path, comprising:
a variable compensator of dispersion for compensating for waveform degradation of said optical signal;
a monitoring circuit for generating a quality information of transmission path of the optical signal which has been compensated for the waveform degradation by the variable compensator of dispersion; and
a controlling circuit for controlling an amount of dispersion compensation in the variable compensator of dispersion, based on the quality information of transmission path generated by the monitoring circuit, so as to become a quality of transmission path to a best value, the controlling circuit for sweeping across a variable range of the amount of dispersion compensation in the variable compensator of dispersion, to thereby determine the quality of transmission path, the controlling circuit for setting the amount of the dispersion compensation corresponding to the best value of the quality of transmission path as a value of initial setting in the variable compensator of dispersion.

2. An apparatus for controlling compensation of dispersion for compensating for waveform degradation of optical signal caused by characteristic of wavelength dispersion on an optical transmission path, comprising:
a variable compensator of dispersion for compensating for waveform degradation of said optical signal;
a monitoring circuit for generating a quality information of transmission path of the optical signal which has been compensated for the waveform degradation by the variable compensator of dispersion; and
a controlling circuit for controlling an amount of dispersion compensation in the variable compensator of dispersion, based on the quality information of transmission path generated by the monitoring circuit, so as to become a quality of transmission path to a best value, the controlling circuit for sweeping across a variable range of the amount of dispersion compensation in the variable compensator of dispersion, to thereby determine the quality of transmission path, the controlling circuit for setting a center value in a range of the amount of dispersion compensation when the quality of transmission path becomes higher than a preset threshold as a value of initial setting in the variable compensator of dispersion.

3. A apparatus for controlling compensation of dispersion according to claim 1 or 2,
wherein the quality of transmission path is adopted a bit error rate.

4. A apparatus for controlling compensation of dispersion according to claim 3,
wherein the controlling circuit sweeps across the variable range of the amount the dispersion compensation in the variable compensator of dispersion, to thereby execute a detection of synchronization and/or a calculation of bit error rate, and skips through a designated step on the sweeping, to thereby find the value of initial setting when the synchronization is not detected.

5. An apparatus for controlling compensation of dispersion according to claim 1,
wherein the controlling circuit sets initially a first threshold and a second threshold that is lower quality of transmission path than the first threshold on the quality of transmission path, the controlling circuit sweeps across a variable range of the amount of dispersion compensation in the variable compensator of dispersion when the quality of transmission path becomes lower than the first threshold, to thereby re-set an amount of dispersion compensation corresponding to a best value of the quality of transmission path in the variable compensator of dispersion.

6. An apparatus for controlling compensation of dispersion according to claim 2,
wherein the controlling circuit sets initially a first threshold and a second threshold that is lower quality of transmission path than the first threshold on the quality of transmission path, the controlling circuit sweeps across a variable range of the amount of the dispersion compensation in the variable compensator of dispersion when the quality of transmission path becomes lower than the first threshold, to thereby re-set a center value in a range of the amount of dispersion compensation when the quality of transmission path becomes higher than the second threshold in the variable compensator of dispersion.

7. A method for controlling compensation of dispersion for compensating for waveform degradation of optical signal caused by characteristic of wavelength dispersion on an optical transmission path, comprising the steps of:
compensating a wavelength dispersion of the optical signal which has been degraded waveform by a variable compensator of dispersion;
determining a quality of transmission path based on a quality information of transmission path of an optical signal which has been compensated for the wavelength degradation;
controlling the amount of dispersion compensation in the variable compensator of dispersion, so as to become the quality of transmission path to a best value;
at initial setting,
sweeping across the variable range of the amount of dispersion compensation in the variable compensator of dispersion, to thereby determine the quality of transmission path; and
setting the amount of dispersion compensation corresponding to the best value of the quality of transmission path as a value of initial setting in the variable compensator of dispersion.

8. A method for controlling compensation of dispersion for compensating for waveform degradation of optical signal caused by characteristic of wavelength dispersion on an optical transmission path, comprising the steps of:
compensating a wavelength dispersion of the optical signal which has been degraded waveform by a variable compensator of dispersion;
determining a quality of transmission path based on a quality information of transmission path of an optical signal which has been compensated for the wavelength degradation;
controlling the amount of dispersion compensation in the variable compensator of dispersion, so as to become a quality of transmission path to a best value;
at initial setting,
sweeping across the variable range of the amount of dispersion compensation in the variable compensator of dispersion, to thereby determine the quality of transmission path; and
setting a center value in a range of the amount of dispersion compensation when the quality of transmission path becomes higher than a preset threshold as a value of initial setting in the variable compensator of dispersion.

9. A method for controlling compensation of dispersion according to claim 7 or 8,
wherein the quality of transmission path is adopted a bit error rate.

10. A method for controlling compensation of dispersion according to claim 9, the method for controlling compensation of dispersion further comprising the steps of:
at initial setting,
sweeping across the variable range of the amount of dispersion compensation in the variable compensator of dispersion, to thereby execute a determination of a bit error rate and a detection of synchronization; and
skipping through designated steps on the sweeping, to thereby determine the bit error rate when the synchronization is not detected.

11. A method for controlling compensation of dispersion according to claim 10, the method for controlling compensation of dispersion further comprising the steps of:
at initial setting,
sweeping across the variable range of the amount of dispersion compensation in the variable compensator of dispersion, to thereby execute the determination of the bit error rate and a detection of synchronization that detects under conditions of loss of frame, out of frame, and the bit error rate below a designated bit error rate.

12. A method for controlling compensation of dispersion according to claim 7, the method for controlling compensation of dispersion further comprising the steps of:
setting initially a first threshold and the second threshold that is lower quality of transmission path than the first threshold on the quality of transmission path;
sweeping across a variable range of the amount of dispersion compensation in the variable compensator of dispersion when the quality of transmission path becomes lower than the first threshold, to thereby re-set an amount of dispersion compensation corresponding to a best value of the quality of transmission path in the variable compensator of dispersion.

13. A method for controlling compensation of dispersion according to claim 8, the method for controlling compensation of dispersion further comprising the steps of:
setting initially a first threshold and the second threshold that is lower quality of transmission path than the first threshold on the quality of transmission path;
sweeping across a variable range of the amount of dispersion compensation in the variable compensator of dispersion when the quality of transmission path becomes lower than the first threshold, to thereby re-set a center value in a range of the amount of dispersion compensation when the quality of transmission path becomes higher than the second threshold in the variable compensator of dispersion.
